(19) United States
(12) Patent Application Publication
(10) Pub. No.: US 2019/0163537 A1
(43) Pub. Date: May 30, 2019

(54) OVER-THE-AIR SOFTWARE DISTRIBUTION METHOD

(71) Applicant: TP Vision Holding B.V., Amsterdam (NL)

(72) Inventor: Gyana Ranjan SENAPATI, Bangalore (IN)

(21) Appl. No.: 15/823,058

(22) Filed: Nov. 27, 2017

(51) Int. Cl. G06F 9/50; G06F 9/445; G06F 8/65; H04H 20/33

(52) U.S. Cl. CPC G06F 9/5061; H04H 20/33; G06F 8/65; G06F 8/63

(57) ABSTRACT

An over-the-air software distribution method is implemented by a computerized software distribution system, and includes steps of: splitting a to-be-distributed software image into a plurality of split image parts; encapsulating the split image parts into a plurality of data streams, respectively; and broadcasting the data streams in parallel.

### FIELD

The disclosure relates to a software distribution method, and more particularly to an over-the-air software distribution method.

### BACKGROUND

Recently, OAD (over-the-air download) has lost its importance in ATSC/DVB (ATSC: advanced television systems committee; DVB: digital video broadcasting) receivers. The main reason for the plunge in popularity of the OAD resides in its longer time required for downloading, particularly for large software images, which are transmitted as DSM-CC (digital storage media command and control) sections each having a maximum section size of 4K bytes in the conventional OAD technology. ATSC/DVB receiver manufacturers are now relying more on IP based software download technologies. However, it is difficult to perform software upgrades on all target devices without using the OAD technology.

### SUMMARY

Therefore, an object of the disclosure is to provide an over-the-air software distribution method that can alleviate at least one of the drawbacks of the prior art.

According to the disclosure, the over-the-air software distribution method is to be implemented by a computerized software distribution system, and includes: splitting a to-be-distributed software image into a plurality of split image parts; encapsulating the split image parts into a plurality of data streams, respectively; and broadcasting the data streams in parallel.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating operation of an embodiment of the over-the-air software distribution method according to the disclosure; and

FIG. 2 is a schematic diagram illustrating an exemplary implementation of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

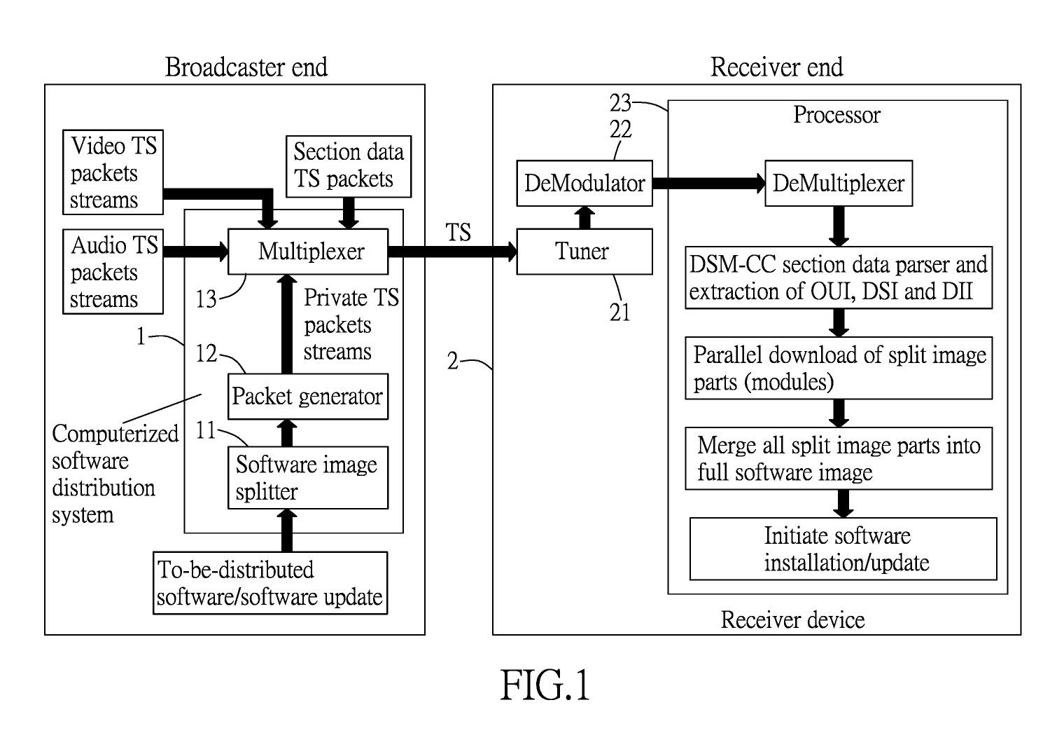

Referring to FIG. 1, the embodiment of the over-the-air software distribution method according to this disclosure is implemented by a computerized software distribution system 1 at a broadcaster end in order to provide images of software or software update to a plurality of receiver devices, such as DTV (digital television) set-top boxes. An image of software may be a computer file that contains all content of the software. In FIG. 1, only one receiver device 2 is shown for the sake of clarity. Hereinafter, the embodiment will be described on a basis of MPEG-2 standard, but this disclosure is not limited in this respect. The method has no dependency on video or audio coding standard, and may be compatible with other standards, such as MPEG-4, HEVC (high efficiency video coding), etc.

In this embodiment, the computerized software distribution system 1 is configured or programmed to have a software image splitter 11, a packet generator 12, and a multiplexer 13. The software image splitter 11 splits a software or software update image, which is to be distributed to the receiver devices, into multiple split image parts so as to be organized into modules for data transport (with each split image part serving as a module for data transport), and then the split image parts are provided to the packet generator 12.

The packet generator 12 encapsulates the split image parts respectively into multiple private packetized elementary streams (PESs, whose structure may be defined in a conventional standard, e.g., the MPEG-2 standard) (data streams) each having an individual PID (packet identifier), and encapsulates each of the private packetized elementary streams into a private transport stream (TS) packet stream. In detail, the packet generator 12 splits each module into multiple blocks, and encapsulates the blocks into PES packets to form a respective private PES for each module. It is noted that, in the MPEG-2 standard, the packetized elementary streams provide a mechanism to transmit data entities of variable size with a maximum length of 64 Kbytes in a PES packet, which is much larger than that for a DSM-CC section (4K bytes), resulting in a higher bitrate for data transmission, and thereby significantly reducing time required for downloading. In addition, because the DSM-CC standard defines that each module can contain 65535 blocks at maximum, this implementation may enable vendors that provide the software or software update (e.g., receiver manufacturers) to transmit software images with larger image size using OAD technology.

The multiplexer 13 combines PES packets of the private TS packet streams with, for example, audio TS packet streams (originating from audio packetized elementary streams), video TS packet streams (originating from video packetized elementary streams), and DSM-CC section data TS packets (originating from DSM-CC section data), etc., to form a transport stream (data stream group), where the DSM-CC section data may contain information related to the packetized elementary streams, such as OUIs (organizationally unique identifier), DSI (download server initiated) messages, DII (download information indication) messages, etc. The transport stream is transmitted after modulation, thereby broadcasting the private packetized elementary streams in parallel along with the other audio/video packetized elementary streams and DSM-CC section data at a specific frequency, which may fall within a range of radio frequency.

At the receiver side, the receiver device 2 may include a tuner 21 to receive the modulated transport stream at the specific frequency, a demodulator 22 (which may be either hardware-implemented or software-implemented) to demodulate the modulated transport stream, and a processor 23. The processor 23 may be configured/programmed to demultiplex the (demodulated modulated) transport stream (i.e., to separate the packetized elementary streams and the DSM-CC section data from the transport stream), and to parse and extract the OUIs, DSI and/or DII messages from the DSM-CC section data of the transport stream. Then, the processor 23 may download the blocks of the modules from the private packetized elementary streams based on the DSI and/or DII messages in parallel. After completion of downloading all of the blocks of any one of the modules, the processor 23 may reassemble the blocks into the corresponding module. After all of the modules have been reassembled, the processor 23 merges the modules into the full software or software update image, and then initiates installation or update process for the software or software update.

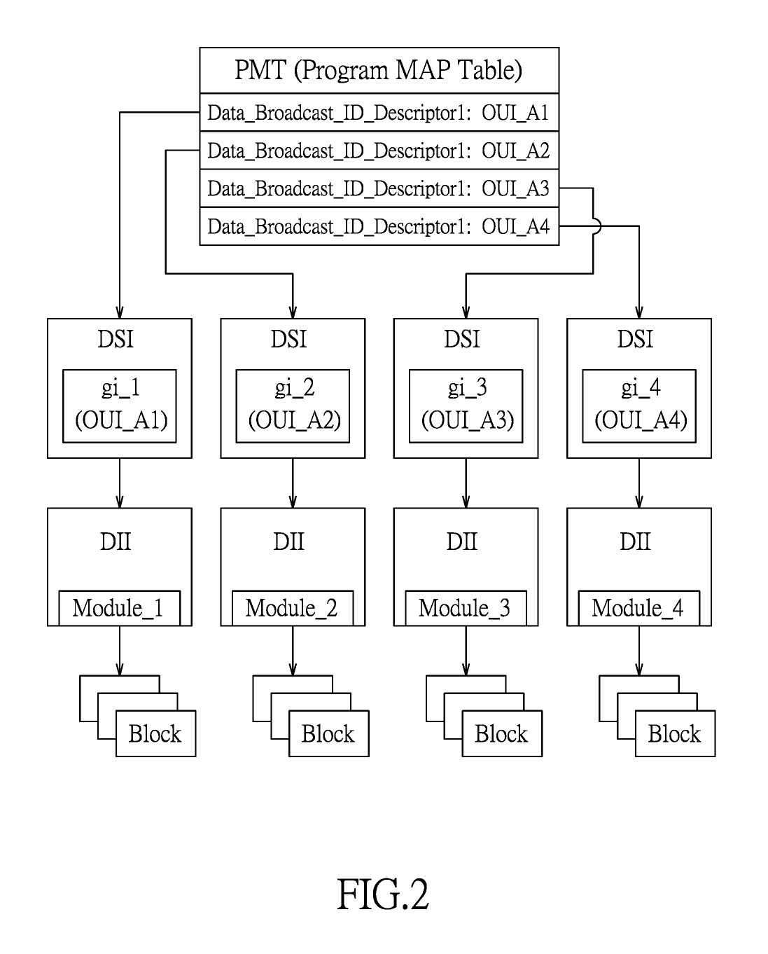

FIG. 2 depicts an exemplary implementation of the embodiment that employs existing DSM-CC protocol, where a software update image is split into four target modules (Module_1 to Module_4) each representing a respective split image part and each being further split into a plurality of blocks (DDB). Each target module may be clustered with modules of other software images of the vendor to form a group corresponding to the vendor (however, only the target modules are shown in FIG. 2 for the sake of clarity), where the group has a corresponding DII message describing all of the modules in the group. A plurality of groups, which may originate from the same vendor or different vendors and each of which has a corresponding DII message (note that only the DII messages corresponding to the target modules are shown in FIG. 2 for the sake of clarity), may be clustered to form a super group that corresponds to a respective packetized elementary stream and that has a corresponding DSI message describing all of the groups in the super group and having a group-info indication (gi_1 to gi_4) related to the corresponding OUI (OUI_A1 to OUI_A4)). In such a case, a PMT (program map table) included in the DSM-CC section data of the transport stream may include four Data_Broadcast_ID_Descriptors, each containing an OUI (OUI_A1 to OUI_A4) that identifies the vendor of the software update and that indicates a respective one of the DSI messages. This scenario enables parallel download for the four target modules (Module_1 to Module_4), reducing time required for downloading.

In view of the above, the over-the-air software distribution method according to this disclosure can achieve efficient download for software or software update images by: 1) splitting the to-be-distributed software image into multiple parts, thereby enabling parallel download for saving the download time; and 2) encapsulating each split software part as a private packetized elementary stream, which has a larger maximum block size in comparison to the conventional DSM-CC section data, thereby increasing the download speed.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. An over-the-air software distribution method to be implemented by a computerized software distribution system, comprising:
splitting a to-be-distributed software image into a plurality of split image parts;
encapsulating the split image parts into a plurality of data streams, respectively; and
broadcasting the data streams in parallel,
wherein each of the data streams is a private packetized elementary stream in compliance with an MPEG-2 standard.

2. The over-the-air software distribution method of claim 1, wherein the broadcasting the data streams in parallel includes:
forming the data streams into a data stream group; and
broadcasting the data stream group.

3. The over-the-air software distribution method of claim 2, wherein the data stream group is an MPEG transport stream.

4. The over-the-air software distribution method of claim 2, wherein the data stream group includes section data that contains information related to the data streams;
the over-the-air software distribution method being implemented by the computerized software distribution system in cooperation with a receiver device that receives the data stream group, and further comprising:
parsing and extracting, by the receiver device, the information related to the data streams from the data stream group;
downloading, by the receiver device, the split image parts from the data streams in parallel based on the information related to the data streams; and
merging, by the receiver device after completely downloading the split image parts, the split image parts into the to-be-distributed software image.

5. The over-the-air software distribution method of claim 4, wherein the data stream group is an MPEG transport stream, and the section data is in compliance with a section data format defined in a DSM-CC standard.

6. (canceled)
